(19) United States
(12) Patent Application Publication
(10) Pub. No.: US 2010/0106644 A1
(43) Pub. Date: Apr. 29, 2010

(54) System and Method for Authorizing Transactions Via Mobile Devices

(75) Inventors: David ANNAN, Oakville (CA); Albert WAHBE, Etobicoke (CA); Hussam MAHGOUB, Toronto (CA)

Correspondence Address: LANG MICHENER, BROOKFIELD PLACE, P.O. BOX 747, SUITE 2500, 181 BAY STREET, TORONTO, ON, M5J 2T7, CA

(73) Assignee: Diversinet Corp., Toronto (CA)

(21) Appl. No.: 12/604,171

(22) Filed: Oct. 22, 2009

Related U.S. Application Data
(60) Provisional application No. 61/107,939, filed on Oct. 23, 2008.

(30) Foreign Application Priority Data
Jun. 12, 2009 (CA) 2668799

(51) Int. Cl. G06Q 40/00; H04M 3/42

(52) U.S. Cl. 705/42; 455/414.1

(57) ABSTRACT

A system and method for authorizing transfers via mobile devices are provided. The system includes a first mobile device and a server. The first mobile device executes a transfer authorization application that allows a user to enter transfer information for a transfer. In response, the transfer authorization application generates and communicates a transfer request for the transfer. The transfer information includes an identifier associated with a recipient and a transfer amount. The server has a data store storing account details for a first account of the user. The server receives the transfer request from the mobile device, verifies that the user has resources in the first account for the transfer request, and sends a notification to a second mobile device associated with the identifier of the recipient. The server then transfers the transfer value from the first account to a second account of the recipient.

### FIELD OF THE INVENTION

The present invention relates to the field of exchange. In particular, it relates to a system and method for authorizing transfers via mobile devices.

### BACKGROUND OF THE INVENTION

In a world of ever-increasing complexity, a person can find himself or herself carrying an increasing number of bank and debit cards that enable payments to be made. Retail locations and the like have hardware systems and use services that enable them to process such payments. These hardware systems are costly and cumbersome, and are thus generally not available to the average person. As a result, transfers between individuals have generally occurred using traditional methods, such as an exchange of cash or a cheque.

It is an object of the invention to provide a novel system and method for authorizing transfers via mobile devices.

### SUMMARY OF THE INVENTION

In an aspect of the invention, there is provided a system for authorizing transfers via mobile devices, comprising:

a first mobile device executing a transfer authorization application, said transfer authorization application allowing a user to enter transfer information for a transfer and, in response, generating and communicating a transfer request for said transfer, said transfer information including an identifier associated with a recipient and a transfer amount; and

a server having a data store storing account details for a first account of said user, said server receiving said transfer request from said mobile device, verifying that said user has resources in said first account for said transfer request, sending a notification to a second mobile device associated with said identifier of said recipient and transferring said transfer value from said first account to a second account of said recipient.

The transfer request can include a one-time password generated by the transfer authorization application. The one-time password can be generated using a stored counter and a credential stored on the mobile device.

The transfer authorization application can encrypt the transfer request prior to communication to the server.

The mobile transaction server can calculate and communicate a service charge for the transfer to the first mobile device for approval.

The mobile transaction server can convert the transfer value from a first currency of the transfer value to a second currency of the first account prior to communication to the first mobile device for approval.

The mobile transaction server can transfer the transfer value to an escrow account.

The server can transfer the transfer value from the escrow account to the second account upon receipt of a receive request from the second mobile device. The server can transfer the transfer value from the escrow account to the first account if the receive request is not received within a pre-set period of time. The second mobile device can generate a one-time password and transmit it with the receive request to the server.

In another aspect of the invention, there is provided a method for authorizing transfers via mobile devices using a server, comprising:

receiving from a first mobile device registered to a transferor a transfer request specifying a transfer value and a recipient identifier associated with a recipient for a transfer;

confirming that said transferor has resources in a first account for said transfer; and

transferring said transfer value from said first account to a second account of said recipient.

The transfer request can include a one-time password generated by the first mobile device, and the method can include:

cancelling said transfer if said one-time password is invalid.

The transfer request can be encrypted by the first mobile device, and the method can include:

decrypting the transfer request received from the first mobile device.

The method can further include:

calculating a service charge for said transfer; and

transmitting a total cost for said transfer including said service charge to said first mobile device for approval.

The method can further include:

converting said transfer amount from a first currency to a second currency corresponding to the currency of said first account; and

transmitting a total cost for said transfer to said first mobile device for approval.

The method can further include:

transferring said transfer amount from said first account to an escrow account.

The method can further include:

sending a notification of said transfer to a second mobile device associated with said identifier;

receiving a confirmation reply from said recipient via said second mobile device; and

wherein said transferring comprises transferring said transfer amount to said second account if said confirmation reply confirms said transfer.

The transferring can include transferring said transfer amount to said second account if said confirmation reply confirms said transfer within a pre-set period of time. The transferring can be performed if a one-time password received with the confirmation reply from the second mobile device is valid.

The method can further include, after the transferring:

sending a transfer completion notice to said first mobile device and said second mobile device.

Other and further advantages and features of the invention will be apparent to those skilled in the art from the following detailed description thereof, taken in conjunction with the accompanying drawings.

### BRIEF DESCRIPTION OF THE DRAWINGS

An embodiment will now be described, by way of example only, with reference to the attached Figures, wherein:

FIG. 1 is a schematic diagram of a system for authorizing transfers via mobile devices and its operating environment in accordance with an embodiment of the invention;

FIG. 2 is a schematic diagram of a mobile device in the system of FIG. 1;

FIG. 3 shows a flowchart of the general method for authorizing transfers via the system of FIG. 1;

FIG. 4 shows a main screen of a transfer authorization application executing on the mobile devices of FIG. 1 for transferring and receiving funds;

FIG. 5 shows a transfer screen of the transfer authorization application enabling a user to enter transfer information and commence the transfer;

FIG. 6 shows the process of validating the transfer request, converting the currency and calculating a service charge of FIG. 3 in greater detail; and

FIG. 7 shows a receive screen of the transfer authorization application enabling a user to receive a transfer.

### DETAILED DESCRIPTION OF THE EMBODIMENT

The invention provides a system and method for authorizing transfers via a mobile device. Mobile devices have become ubiquitous. Many people have even cancelled traditional landline telephone services at their residences and/or businesses, and have adopted mobile phones as their primary means of communications. Accordingly, many people typically carry such mobile devices with them wherever they go. For purposes of the discussion hereinbelow, mobile devices include mobile telephones, personal digital assistants, and other portable computing devices that have a network communications interface and an output interface, such as a display. Mobile devices can include a subscriber identification module (“SIM”) card that can provide additional capabilities and/or capacity. By enabling people to execute transfers between themselves via mobile devices in a facilitated manner, they can address transfers immediately without having to have immediate access to cash, a personal computer, etc.

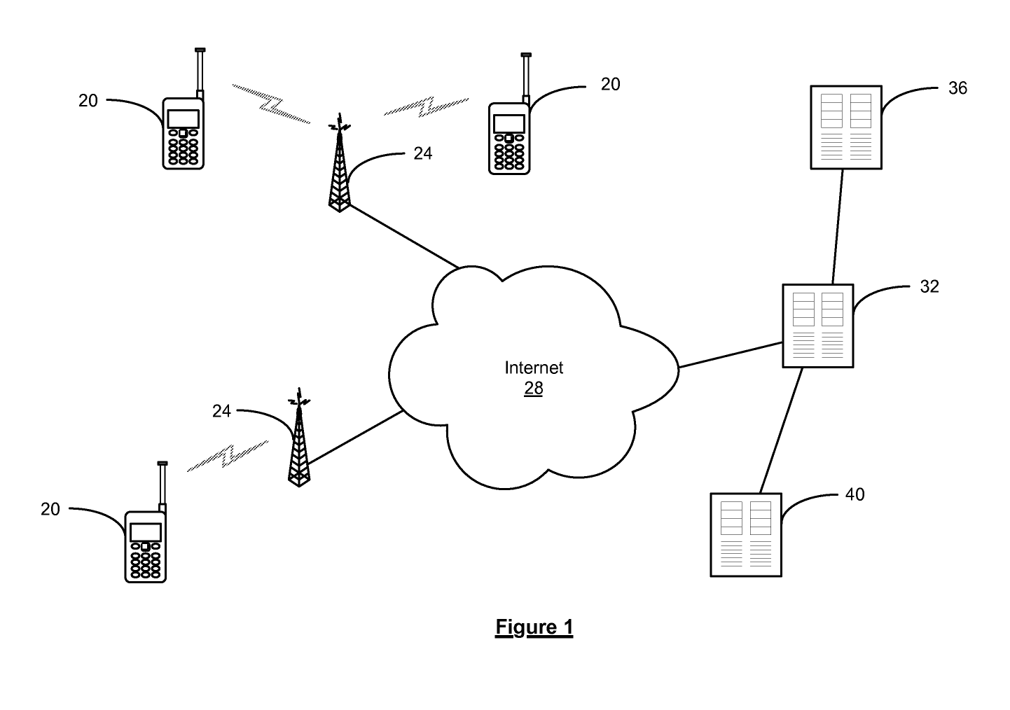

A system for authorizing transfers via mobile devices and its operating environment in accordance with an embodiment of the invention is shown in FIG. 1. The embodiment described herein relates to a system for transferring money between two parties: in this case, two individuals. Each individual is equipped with a mobile device, more specifically a mobile phone, that has a transfer authorization application installed on it. In order to transfer money to another person, a user starts up the transfer authorization application, either selects a recipient from a list or enters in a new recipient, enters an amount to transfer and presses a button to start the transfer. The transfer authorization application generates and sends a transfer request to a mobile transaction server over a cellular network. Upon receiving the transfer request, the mobile transaction server verifies the sender's identity, confirms that the transferor has the necessary funds in his account available for transfer, performs a number of confirmation steps, and transfers the funds to an account registered to the recipient.

A number of mobile devices 20 are shown in communication wirelessly with cellular base stations 24 via cellular communications. The cellular base stations 24 enable communications over a large, public network, such as the Internet 28, via a number of intermediate servers operated by one or more cellular communications carriers (not shown). A mobile transaction server 32 is also in communication with the Internet 28. The mobile transaction server 32 is also in communication with an OATH validation server 36 over a private network. Additionally, the mobile transaction server 32 is in communication with one or more financial institutions 40 where the users of the mobile devices 20 have financial accounts.

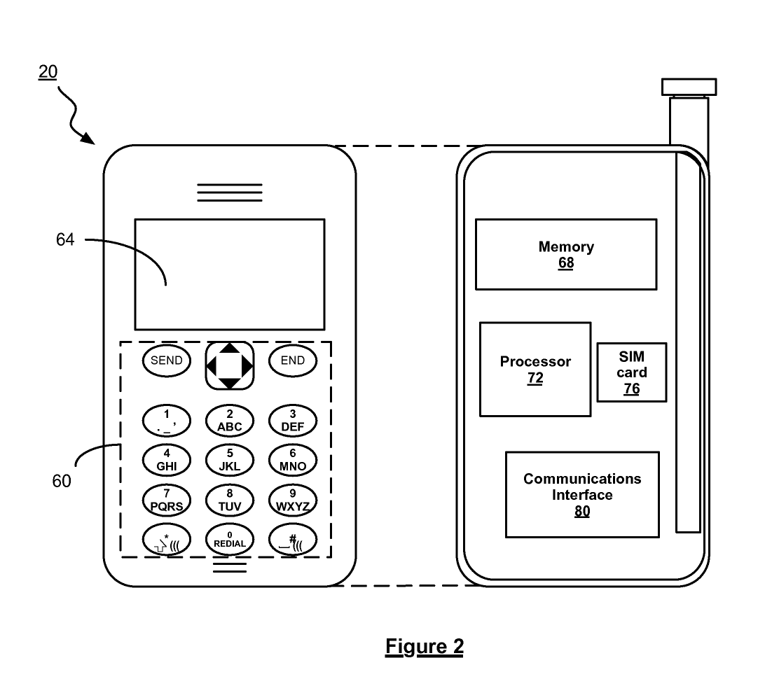

Referring to FIG. 2, a number of components of the mobile device 20 are shown. As illustrated, in this embodiment, the mobile device 20 is a typical mobile phone having basic functions. The mobile device 20 has an input interface 60 for receiving input from a user, and a display 64 is provided for presenting information visually to the user. The mobile device 20 also includes memory 68 for storing an operating system that controls the main functionality of the mobile device 20, along with a number of applications that are run on the mobile device 20, and data. A processor 72 executes the operating system and applications. A SIM card 76 provides additional memory for storing applications and data, and has a microprocessor for executing them. Additionally, the SIM card 76 has a unique hardware identification code that permits identification of the mobile device 20. When installed, the SIM card 76 forms part of the mobile device 20. Other types of mobile devices can have encrypted device memory in place of the SIM card 76 which offers the equivalent functionality. A communications interface 80 permits communications with a cellular network for voice and data.

In order to enable the mobile device 20 to authorize transfers in the system, the user of the mobile device 20 registers with the transfer service via a webpage, either on the mobile device 20 or elsewhere. During registration, the user provides his name and address, an active credit or debit card number to register as an account from which funds can be withdrawn or to which funds can be deposited, and the telephone number associated with the mobile device 20 that he wishes to access the service with. The user is then directed to authorize a transfer of a nominal amount to the transfer service to confirm the account details. In addition, the user is asked for authorization for future transfers under the service. The user may be required to provide account credentials at this time, depending on the policies of the financial institution. Once registration is complete, a link is provided to enable the downloading and installation of a transfer authorization application on the mobile device 20. The transfer authorization application can be downloaded either directly by the mobile device 20 or via a computer and transferred to the mobile device 20 for installation.

Once the transfer authorization application is installed on the mobile device 20, the transfer authorization application directs the user to enter a username and password established during registration with the transfer service and then select a personal identification number (“PIN”) that will need to be entered every time the transfer authorization application is started up to authenticate the user. The transfer authorization application then securely obtains a TokenID from the mobile transaction server 32, along with a credential and a counter associated with the TokenID. The credential is a long binary number used as a fixed key for generating one-time passwords (“OTPs”). The counter is an event-based incrementing integer value. The credential and the counter are shared with the mobile transaction server 32 and enable the generation of OTPs by the mobile device 20 and their validation by the mobile transaction server 32. The mobile transaction server 32 registers the telephone number of the mobile device 20, together with the TokenID. In turn, the mobile transaction server 32 transmits the TokenID, the credential and the counter to the OATH validation server 36. The counter on the mobile device 20 is synchronized with the counter stored by the OATH validation server 36 at this time.

After the setup procedure, the transfer authorization application is able to present options to, and receive input from, the user, and carry out communications over the Internet 28 via the communications interface of the mobile device 20.

Once the transfer authorization application has been installed and configured on the mobile device 20, the mobile device 20 can be used to authorize transfers.

Hereinafter, a person desiring to transfer funds shall be referred to as a “transferor” and a person to whom the transferor desires to transfer funds shall be referred to as a “recipient”.

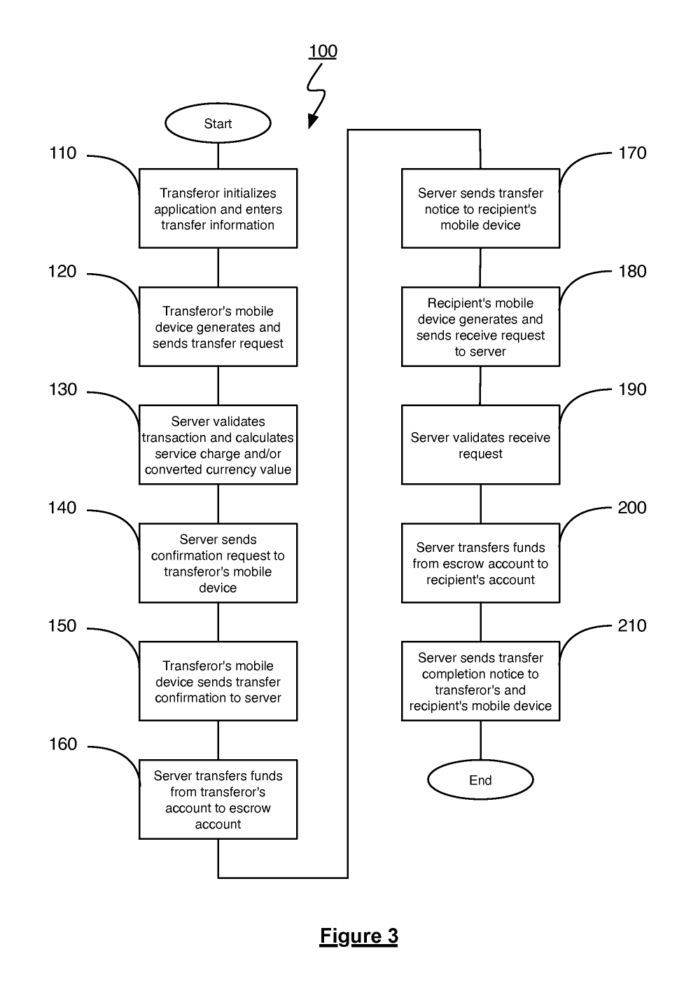

FIG. 3 illustrates the method of authorizing a transfer using the system shown in FIG. 1 generally at 100. When the transferor wishes to transfer money to a recipient, he or she requests from the recipient the telephone number of a mobile device 20 associated with the recipient, if not already known. Once the transferor has the telephone number associated with the mobile device 20 of the recipient, the transferor is ready to begin the transfer.

The method begins when the user initializes the transfer authorization application on the mobile device 20 and enters in transfer information (step 110). When the transfer authorization application is started up, the transferor enters the PIN established during setup when visually prompted by the transfer authorization application via the display 64 of the mobile device 20. Once the transferor has authenticated himself with the transfer authorization application, he selects to initiate a transfer, then enters in the transfer information when prompted. The transfer information includes the telephone number of the recipient and the amount and currency that the transferor desires to transfer to the recipient.

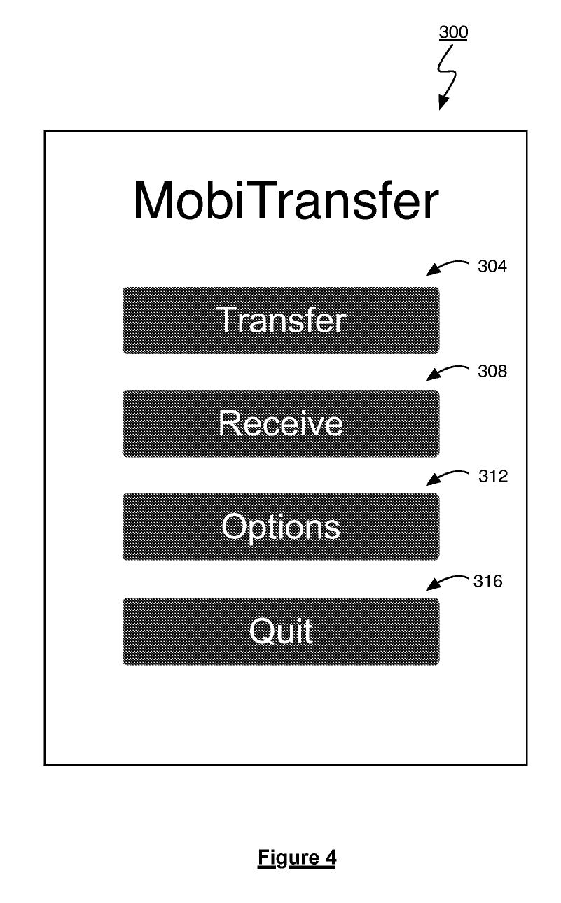

FIG. 4 shows a main screen 300 of the transfer authorization application that is presented to a user upon starting it up and entering in the PIN. The main screen 300 has a menu for allowing a user to access other screens. The menu includes a transfer screen button 304, a receive screen button 308, an options screen 312 and an exit button 316 for allowing a user to exit from the transfer authorization application.

In order to commence the transfer, the transferor activates the transfer button 304.

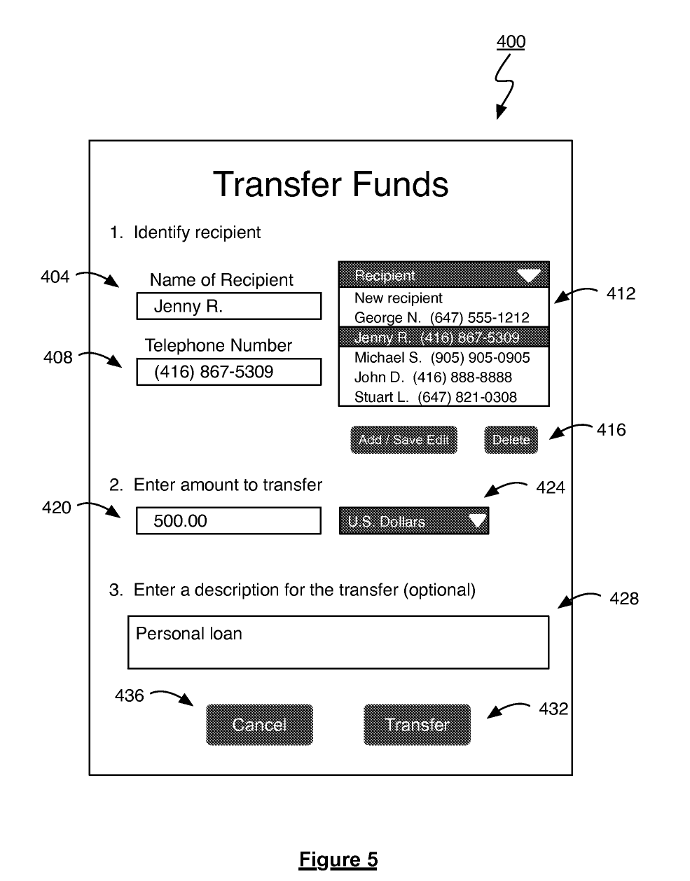

FIG. 5 shows a transfer screen 400 that is presented upon activation of the transfer button 304 of the main screen 300. The transfer screen 400 allows entry of the transfer information and commencement of the transfer. The transfer screen 400 includes a name field 404 and a telephone number field 408 for identifying the recipient of the transfer. A drop-down recipient list 412 enables the transferor to bypass manual entry of this information by selecting a previously-entered recipient and telephone number, thus filling in the name and telephone number fields 404, 408 respectively. A set of buttons 416 enables the user to add, save an edit to or delete a recipient in the drop-down recipient list 412. The amount to be transferred is entered into a transfer amount field 420 and the currency for the amount is selected from a drop-down currency list 424. The transferor can optionally enter a description for the transfer in a description field 428 for later identification of the transfer. Once the transfer information is correct, the transferor can commence the transfer by activating a transfer button 432 or, alternatively, cancel the transfer by activating a cancel transfer button 436.

Returning to FIG. 3, once the transferor enters the transfer information and activates the transfer button 432, the mobile device 20 generates and sends a transfer request to the mobile transaction server 32 (step 120). In order to enable authentication of the transfer, the transfer authorization software generates an OTP for the transfer. In particular, the transfer authorization application uses the stored counter and credential received during the setup of the transfer authorization application to generate the OTP using the standard OATH algorithm, as set out in IETF “HOTP: An HMAC-Based OTP Algorithm (RFC 4226)”. Once the transfer authorization application on the mobile device 20 has generated the OTP, it encrypts and sends the transfer request to the mobile transaction server 32. The transfer request includes the transfer information (i.e., the recipient's name and telephone number, and the transfer amount and currency), the OTP and the telephone number associated with the mobile device 20. The transfer authorization module transmits the encrypted transfer request using a wireless bearer system such as User Datagram Protocol (“UDP”) to a proximate one of the cellular base stations 24 for forwarding to the mobile transaction server 32.

Upon receipt of the encrypted transfer request, the mobile transaction server 32 decrypts and validates the transfer request, and calculates the converted currency amount, if required, and service charge associated with the transfer (step 130).

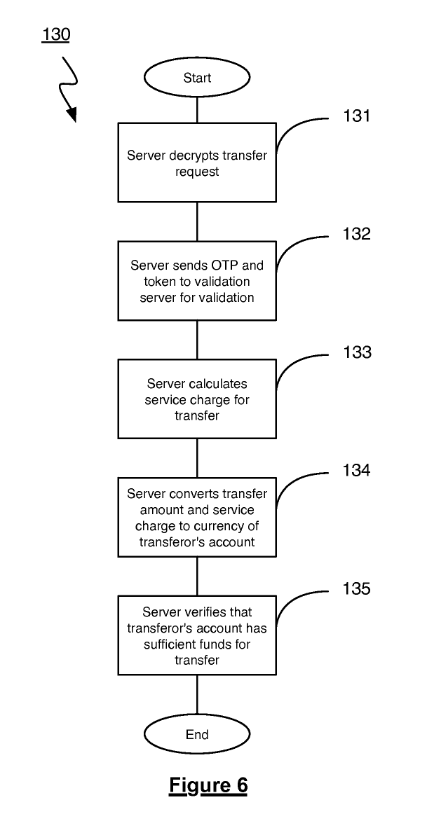

FIG. 6 shows the steps performed during validation of the transfer request, and calculation of the converted amount and any service charge. When the mobile transaction server 32 receives the transfer request, it decrypts the transfer request to receive the transfer information and the OTP (step 131). The mobile transaction server 32 then sends the TokenID for the transferor's mobile device 20 and the OTP to the OATH validation server 36 for validation (step 132). The mobile transaction server 32 looks up the TokenID corresponding to the telephone number of the mobile device 20 of the transferor. The OATH validation server 36 validates the OTP using the credentials and counter associated with the TokenID passed on by the mobile transaction server 32 using the OATH standard validation methodology. In order to handle minor de-synchronizations between the counter stored on the mobile device 20 and that stored by the OATH validation server 36, the OATH validation server 36 actually validates over a window of counter values typically including the current counter value and 10-20 counter values ahead when validating an OTP. The counter value is updated to match any stored by the OATH validation server 36 tried counter value yielding an OTP validation to maintain synchronization between the counter values stored by the OATH validation server 36 and the mobile device 20. If none of the tried counter values yields an OTP that matches the OTP received from the mobile device 20, the OTP received from the mobile device 20 is deemed invalid. The OATH validation server 36 replies to the mobile transaction server 32, either validating or rejecting the OTP. If the OATH validation server 36 rejects the OTP, the mobile transaction server 32 ceases further processing of the transfer request and sends an error message to the mobile device 20, thus terminating the transfer. If, instead, the OATH validation server 36 validates the OTP, the mobile transaction server 32 calculates the service charge for the transfer (step 133). The mobile transaction server 32 then calculates the converted currency amount and service charge, if required (step 134). Of note is that the service charge is calculated in the currency of the transferor's account that may differ from the currency specified for the transfer amount. For example, if the transferor banks in Singapore in a U.S. dollar account, the service charge may be, for example, US $1.75 for the transfer, even though the transfer may be in Euros and the transferor may bank in Singapore also. The mobile transaction server 32 compares the currencies for the transfer amount and for the service charge to the currency of the transferor's account at the financial institution 40. If the currency types differ, the mobile transaction server 32 converts the transfer value and/or the service charge into the currency of the transferor's account.

The mobile transaction server 32 then verifies that the transferor's account has sufficient funds available to cover the transfer (step 135). In particular, the mobile transaction server 32 sends a verification request to the financial institution 40. The verification request includes the account information and credentials obtained from the transferor during registration, and the total charge. The financial institution 40 replies to the mobile transaction server 32, either indicating that the transferor's account has sufficient funds available to cover the total charge, or that there is an error. If the transferor's account does not have sufficient funds available to cover the transfer, the mobile transaction server 32 sends a message to the transferor's mobile device 20 to that effect, and the transfer ends.

Returning again to FIG. 3, the mobile transaction server 32 sends a confirmation request to the transferor's mobile device 20 with the total charge in the transferor's local currency (140). Upon receipt of a confirmation request, the transfer authorization application presents the total charge to the transferor, along with the other transfer information, for confirmation. The transferor can confirm or reject the transfer using knowledge of the total charge to his account. If the transferor rejects the transfer, the method 100 ends. If, instead, the transferor confirms the transfer, the mobile device 20 sends a transfer confirmation to the mobile transaction server 32 (step 150).

When the mobile transaction server 32 receives the transfer confirmation, it transfers an amount equal to the total charge from the transferor's account at the financial institution 40 to an escrow account held on behalf of the recipient (step 160).

The mobile transaction server 32 then sends a transfer notice to the mobile device 20 of the recipient and identified in the transfer information provided by the transferor (step 170). The transfer notice is sent via short message service (“SMS”), and indicates that a transfer amount is pending for the recipient. If the recipient is not registered, the transfer notice additionally provides an invitation to join the service, along with a link to a registration page. At this time, the recipient can download and install the transfer authorization application on his mobile device 20 in order to proceed with the transfer. This is done in the same manner as detailed earlier.

When the recipient is ready to receive the transfer, the recipient starts the transfer authorization application, enters in his PIN and then activates the receive screen button 308.

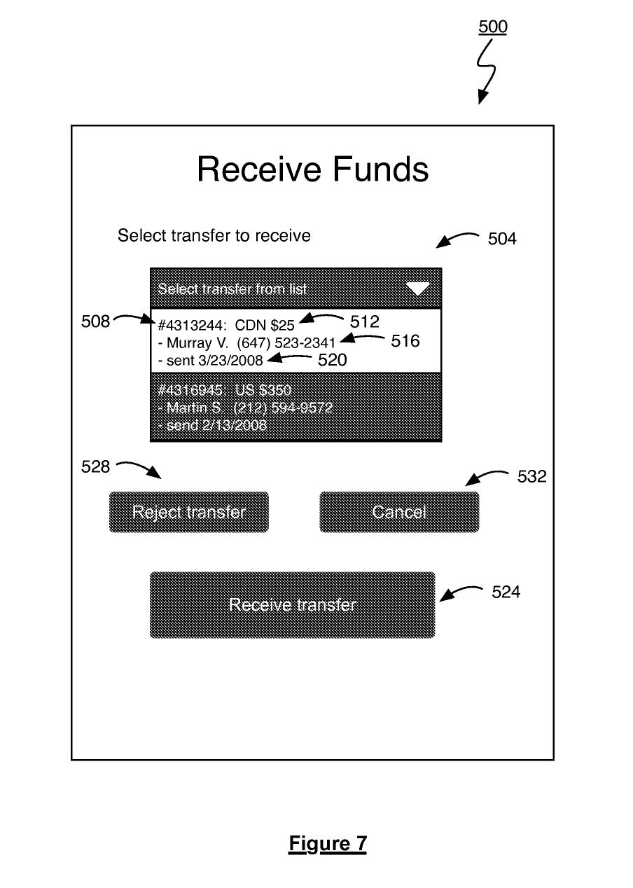

FIG. 7 shows a receive screen 500 that is presented on the mobile device 20 upon activating the receive screen button 308 on the main screen 300. The receive screen 500 allows a user to view pending transfers to them. In order to enable this, the receive screen includes a drop-down pending transfer list 504 that includes a list of all pending transfers for the user. As shown, the drop-down pending transfer list 504 includes details for each transfer, including a transaction ID 508, a transfer amount and currency 512, a transferor name and telephone number 516, and a transfer start date 520. In order to receive a transfer, the recipient selects the transfer from the drop-down pending transfer list 504, and activates a receive transfer button 524. Alternatively, activation of a reject transfer button 528 removes a transfer from the drop-down pending transfer list 504. Activation of a cancel button 532 brings the user back to the main screen 300.

Returning back to FIG. 3, upon activation of the receive transfer button 524, the mobile device 20 of the recipient encrypts and sends a receive request to the mobile transaction server 32 (step 180). In order to enable authentication of the receive request as having been sent by the mobile device 20 of the recipient, the transfer authorization software on the mobile device 20 of the recipient generates an OTP for the receive request, in the same manner as when generating a transfer request at step 120. The receive request includes the transaction ID, the OTP and the telephone number associated with the recipient's mobile device 20. Once the transfer authorization application on the mobile device 20 has generated the OTP, it encrypts and sends the receive request to the mobile transaction server 32.

Upon receipt of the receive request, the mobile transaction server 32 validates the receive request (step 190). In particular, the mobile transaction server 32 extracts the OTP from the receive request, looks up the TokenID associated with the telephone number of the recipient's mobile device 20, and then sends an authentication request to the OATH validation server 36 that includes the OTP and the TokenID. The OATH validation server 36 validates the OTP is the same manner as when validating the OTP received with the transfer request. The OATH validation server 36 then replies to the mobile transaction server 32, either validating or rejecting the OTP. If the validation of the OTP is not successful, the mobile transaction server 32 sends an error message to the mobile device 20 of the recipient.

If, instead, the validation of the OTP is successful, the mobile transaction server 32 transfers the transfer amount from the escrow account to the account of the recipient (step 200). If desired or required by jurisdictional laws, further non-repudiation checks and money-laundering checks can be performed before the transfer is completed.

Once the transfer is complete, the mobile transaction server sends a transfer completion notice to the mobile devices 20 of both the transferor and the transferee (step 210).

If a transfer is commenced by a transferor but not completed by the recipient within a set period of time, the mobile transaction server 32 performs a “fail-back” transaction reversal by transferring the amount held in the escrow account back to the transferor's account.

While the invention has been described with specificity to a fund transfer system between two individuals, those skilled in the art will appreciate that the invention can also be applied to other types of transfer environments. For example, users could share loyalty program rewards and points, as well as service credits and airline points.

The method of originating transfers as described above can be combined with other existing recipient methods such as existing funds transfer points-of-presence to complete transfers in a physical manner.

While the mobile transaction server and the OATH validation server are described as separate servers, those skilled in the art will appreciate that these servers can be combined, with the desired functionality being provided via separate modules thereon.

The transfer authorization application can be installed on a mobile device in a number of other ways, apart from the manner described above. For example, the transfer authorization application can be installed in the firmware of the mobile device at the factory or by a cellular carrier, placed onto a SIM card before deployment of the SIM card in a GSM-type mobile device, etc.

A user can use more than one personal account in conjunction with the transfer service. This can be accommodated, for example, by providing an additional drop-down list on the transfer and receive screens to allow for selection of the desired account.

The mobile device can use other modes of communication to transmit transfer requests, receive transfer notices, etc. For example, the mobile device can generate and transmit the transfer request in an SMS message. The mobile transaction server can transmit the transfer notice via UDP, TCP or another suitable protocol or method.

A registered user can use a web interface of the transfer service to manage a transfer.

The above-described embodiments are intended to be examples of the present invention and alterations and modifications may be effected thereto, by those of skill in the art, without departing from the scope of the invention which is defined solely by the claims appended hereto.

What is claimed is:

1. A system for authorizing transfers via mobile devices, comprising:
a first mobile device executing a transfer authorization application, said transfer authorization application allowing a user to enter transfer information for a transfer and, in response, generating and communicating a transfer request for said transfer, said transfer information including an identifier associated with a recipient and a transfer amount; and
a server having a data store storing account details for a first account of said user, said server receiving said transfer request from said mobile device, verifying that said user has resources in said first account for said transfer request, sending a notification to a second mobile device associated with said identifier of said recipient and transferring said transfer value from said first account to a second account of said recipient.

2. The system of claim 1, wherein said transfer request includes a one-time password generated by said transfer authorization application, and wherein said server cancels said transfer if said one-time password is invalid.

3. The system of claim 1, wherein said transfer authorization application encrypts the transfer request prior to communication to said server.

4. The system of claim 1, wherein said server calculates and communicates a service charge for said transfer to said first mobile device for approval.

5. The system of claim 1, wherein said server converts said transfer value from a first currency specified for said transfer value to a second currency of said first account prior to communication to said first mobile device for approval.

6. The system of claim 1, wherein said server transfers said transfer value to an escrow account.

7. The system of claim 6, wherein said server transfers said transfer value from said escrow account to said second account upon receipt of a receive request from said second mobile device.

8. The system of claim 7, wherein said server transfers said transfer value from said escrow account to said first account if said receive request is not received within a pre-set period of time.

9. The system of claim 7, wherein said second mobile device generates a one-time password and transits it with the receive request to the server.

10. A method for authorizing transfers via mobile devices using a server, comprising:
receiving from a first mobile device registered to a transferor a transfer request specifying a transfer value and a recipient identifier associated with a recipient for a transfer;
confirming that said transferor has resources in a first account for said transfer; and
transferring said transfer value from said first account to a second account of said recipient.

11. The method of claim 10, wherein said transfer request comprises a one-time password generated by said first mobile device, and further comprising:
cancelling said transfer if said one-time password is invalid.

12. The method of claim 10, wherein said transfer request is encrypted by said first mobile device, and further comprising:
decrypting said transfer request received from said first mobile device.

13. The method of claim 10, further comprising:
calculating a service charge for said transfer; and
transmitting a total cost for said transfer including said service charge to said first mobile device for approval.

14. The method of claim 10, further comprising:
converting said transfer amount from a first currency to a second currency corresponding to the currency of said first account; and
transmitting a total cost for said transfer to said first mobile device for approval.

15. The method of claim 10, further comprising:
transferring said transfer amount from said first account to an escrow account.

16. The method of claim 10, further comprising, before said transferring:
sending a notification of said transfer to a second mobile device associated with said identifier;
receiving a confirmation reply from said recipient via said second mobile device; and
wherein said transferring comprises transferring said transfer amount to said second account if said confirmation reply confirms said transfer.

17. The method of claim 16, wherein said transferring comprises transferring said transfer amount to said second account if said confirmation reply confirms said transfer within a pre-set period of time.

18. The method of claim 17, wherein said transferring is performed if a one-time password received with said confirmation reply from said second mobile device is valid.

19. The method of claim 10, further comprising, after said transferring:
sending a transfer completion notice to said first mobile device and said second mobile device.
